(19) United States
(12) Patent Application Publication
(10) Pub. No.: US 2025/0164763 A1
(43) Pub. Date: May 22, 2025

(54) OPTICAL SYSTEM, OPTICAL APPARATUS, AND METHOD FOR MANUFACTURING OPTICAL SYSTEM

(71) Applicant: NIKON CORPORATION, Shinagawa-ku, Tokyo (JP)

(72) Inventor: Satoshi MIWA, Yokohama-shi (JP)

(21) Appl. No.: 19/101,699

(22) PCT Filed: Jul. 28, 2023
(86) PCT No.: PCT/JP2023/027689

§ 371 Date: Feb. 6, 2025

(30) Foreign Application Priority Data
Aug. 9, 2022 (JP) 2022-126743

(51) Int. Cl. G02B 15/14

(52) U.S. Cl. CPC G02B 15/145121

(57) ABSTRACT

An optical system that can obtain favorable optical performance while achieving size and weight reduction, an optical apparatus, and a method for manufacturing the optical system are provided. An optical system OL included in an optical apparatus such as a camera 1 includes, sequentially from an object side, a first lens group G1 having positive refractive power, a second lens group G2 having negative refractive power, a third lens group G3 having positive refractive power, a fourth lens group G4 having negative refractive power, and a fifth lens group G5 having positive refractive power, a space between adjacent lens groups changes at zooming, the second lens group G2 is fixed relative to an image plane at zooming, and the optical system OL satisfies a condition expressed by a predetermined conditional expression.

### TECHNICAL FIELD

The present invention relates to an optical system, an optical apparatus, and a method for manufacturing the optical system.

### BACKGROUND ART

Conventionally, a small-sized zoom lens has been disclosed (refer to Patent Literature 1, for example). However, further size and weight reduction and further improvement of optical performance are required.

### CITATION LIST

### Patent Literature

Patent Literature 1: WO 2016/157340

### SUMMARY OF INVENTION

An optical system according to a first aspect of the present invention includes, sequentially from an object side, a first lens group having positive refractive power, a second lens group having negative refractive power, a third lens group having positive refractive power, a fourth lens group having negative refractive power, and a fifth lens group having positive refractive power, a space between adjacent lens groups changes at zooming, the second lens group is fixed relative to an image plane at zooming, and the optical system satisfies a condition expressed by an expression below,

$$4. < f 1 / 13 < 10.$$

in the expression,
f1: focal length of the first lens group, and
f3: focal length of the third lens group.

An optical system according to a second aspect of the present invention includes, sequentially from an object side, a first lens group having positive refractive power, a second lens group having negative refractive power, a third lens group having positive refractive power, a fourth lens group having negative refractive power, and a fifth lens group having positive refractive power, a space between adjacent lens groups changes at zooming, and the optical system satisfies a condition expressed by expressions below,

$$4. < f 1 / f 3 < 10.$$

$$4. < TLw / fw < 8.$$

in the expressions,
f1: focal length of the first lens group,
f3: focal length of the third lens group,
fw: overall focal length of the optical system in a wide-angle end state, and
TLw: optical total length of the optical system in the wide-angle end state.

A method for manufacturing the optical system according to the first aspect of the present invention is a method for manufacturing an optical system including, sequentially from an object side, a first lens group having positive refractive power, a second lens group having negative refractive power, a third lens group having positive refractive power, a fourth lens group having negative refractive power, and a fifth lens group having positive refractive power, the method includes disposing the lens groups so that a space between adjacent lens groups changes at zooming, disposing the lens groups so that the second lens group is fixed relative to an image plane at zooming, and disposing the lens groups so that a condition expressed by an expression below is satisfied,

$$4. < f 1 / f 3 < 10.$$

in the expression,
f1: focal length of the first lens group, and
f3: focal length of the third lens group.

A method for manufacturing the optical system according to the second aspect of the present invention is a method for manufacturing an optical system including, sequentially from an object side, a first lens group having positive refractive power, a second lens group having negative refractive power, a third lens group having positive refractive power, a fourth lens group having negative refractive power, and a fifth lens group having positive refractive power, the method includes disposing the lens groups so that a space between adjacent lens groups changes at zooming, and disposing the lens groups so that a condition expressed by expressions below is satisfied,

$$4. < f 1 / f 3 < 10.$$

$$4. < TLw / fw < 8.$$

in the expressions,
f1: focal length of the first lens group,
f3: focal length of the third lens group,
fw: overall focal length of the optical system in a wide-angle end state, and
TLw: optical total length of the optical system in the wide-angle end state.

### BRIEF DESCRIPTION OF DRAWINGS

FIG. 1 is a cross-sectional view showing a lens configuration of an optical system according to a first example.

FIG. 2 is a variety of aberration diagram of the optical system according to the first example at focusing on an infinite distance object; (a) shows a wide-angle end state and (b) shows a telephoto end state.

FIG. 3 is a cross-sectional view showing a lens configuration of an optical system according to a second example.

FIG. 4 is a variety of aberration diagram of the optical system according to the second example at focusing on an infinite distance object; (a) shows a wide-angle end state and (b) shows a telephoto end state.

FIG. 5 is a cross-sectional view showing a lens configuration of an optical system according to a third example.

FIG. 6 is a variety of aberration diagram of the optical system according to the third example at focusing on an infinite distance object; (a) shows a wide-angle end state and (b) shows a telephoto end state.

FIG. 7 is a cross-sectional view showing a lens configuration of an optical system according to a fourth example.

FIG. 8 is a variety of aberration diagram of the optical system according to the fourth example at focusing on an infinite distance object; (a) shows a wide-angle end state and (b) shows a telephoto end state.

FIG. 9 is a cross-sectional view of a camera on which an above-described optical system is mounted.

FIG. 10 is a flowchart for description of a method for manufacturing the above-described optical system according to a first embodiment.

FIG. 11 is a flowchart for description of a method for manufacturing the above-described optical system according to a second embodiment.

### DESCRIPTION OF EMBODIMENTS

Preferable embodiments will be described below with reference to the accompanying drawings.

### First Embodiment

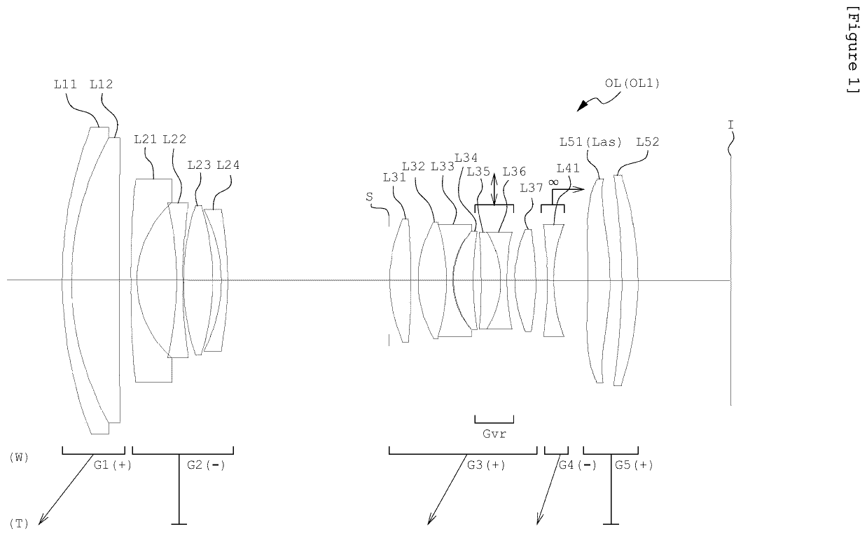

As shown in FIG. 1, an optical system OL according to a first embodiment includes, sequentially from an object side, a first lens group G1 having positive refractive power, a second lens group G2 having negative refractive power, a third lens group G3 having positive refractive power, a fourth lens group G4 having negative refractive power, and a fifth lens group G5 having positive refractive power. Moreover, in the optical system OL, at zooming, the space between adjacent lens groups changes and the second lens group G2 is fixed relative to an image plane. With this configuration, the optical system OL can obtain favorable optical performance while achieving size and weight reduction.

The optical system OL according to the first embodiment preferably satisfies Conditional Expression (1) shown below.

$$4. < f 1 / f 3 < 10. \qquad ( 1 )$$

in the expression,
f1: focal length of the first lens group G1, and
f3: focal length of the third lens group G3.

Conditional Expression (1) defines the ratio of the focal length of the first lens group G1 to the focal length of the third lens group G3. By satisfying Conditional Expression (1), it is possible to obtain favorable optical performance while achieving size and weight reduction of the optical system OL. When the upper limit value of Conditional Expression (1) is exceeded, the focal length of the third lens group G3 is short, in other words, the refractive power of the third lens group G3 is too strong, which makes it difficult to correct spherical aberration in a telephoto end state and thus such a configuration is not preferable. Meanwhile, it is possible to secure the advantageous effect of the present embodiment more surely by setting the upper limit value of Conditional Expression (1) to 8.000. Further, in order to secure the advantageous effect of the present embodiment further more surely, it is preferable to set the upper limit value of Conditional Expression (1) to 7.000. Moreover, when the lower limit value of Conditional Expression (1) is exceeded, the focal length of the first lens group G1 is short, in other words, the refractive power of the first lens group G1 is too strong, which makes it difficult to correct variation in field curvature at zooming and thus such a configuration is not preferable. Moreover, it is possible to secure the advantageous effect of the present embodiment more surely by setting the lower limit value of Conditional Expression (1) to 4.900. Further, in order to secure the advantageous effect of the present embodiment further more surely, it is preferable to set the lower limit value of Conditional Expression (1) to 5.200.

### Second Embodiment

As shown in FIG. 1, the optical system OL according to a second embodiment includes, sequentially from an object side, a first lens group G1 having positive refractive power, a second lens group G2 having negative refractive power, a third lens group G3 having positive refractive power, a fourth lens group G4 having negative refractive power, and a fifth lens group G5 having positive refractive power. Moreover, in the optical system OL, the space between adjacent lens groups changes at zooming. With this configuration, it is possible to obtain favorable optical performance while achieving size and weight reduction of the optical system OL.

The optical system OL according to the second embodiment preferably satisfies Conditional Expression (1) described above. Effects and the like resulting from satisfying Conditional Expression (1) are as described above.

The optical system OL according to the second embodiment preferably satisfies Conditional Expression (2) shown below.

$$4. < TLw / fw < 8. \qquad ( 2 )$$

in the expression,
fw: overall focal length of the optical system OL at focusing on an infinite distance object in a wide-angle end state, and
TLw: optical total length of the optical system OL at focusing on an infinite distance object in the wide-angle end state.

Conditional Expression (2) defines the ratio of the optical total length to the overall focal length of the optical system OL in the wide-angle end state. By satisfying Conditional Expression (2), it is possible to obtain favorable optical performance while achieving size and weight reduction of the optical system OL. When the upper limit value of Conditional Expression (2) is exceeded, the optical total length in the wide-angle end state is long, and as a result, the refractive power of the second lens group G2 is too strong, which makes it difficult to correct spherical aberration in the telephoto end state and thus such a configuration is not preferable. Meanwhile, it is possible to secure the advantageous effect of the present embodiment more surely by setting the upper limit value of Conditional Expression (2) to 7.000. Further, in order to secure the advantageous effect of the present embodiment further more surely, it is preferable to set the upper limit value of Conditional Expression (2) to 6.000. Moreover, when the lower limit value of Conditional Expression (2) is exceeded, the optical total length in the wide-angle end state is short, and as a result, the refractive power of the first lens group G1 is too strong, which makes it difficult to correct variation in field curvature at zooming and thus such a configuration is not preferable. Moreover, it is possible to secure the advantageous effect of the present embodiment more surely by setting the lower limit value of Conditional Expression (2) to 4.200. Further, in order to secure the advantageous effect of the present embodiment further more surely, it is preferable to set the lower limit value of Conditional Expression (2) to 4.400.

### First and Second Embodiments

The optical system OL according to the first or second embodiment (hereinafter referred to as “the present embodiment”) preferably satisfies Conditional Expression (3) shown below.

$$0.5 < ( - f 2 ) / f 3 < 3.0 \; 00 \qquad ( 3 )$$

in the expression,
f2: focal length of the second lens group G2, and
f3: focal length of the third lens group G3.

Conditional Expression (3) defines the ratio of the focal length of the second lens group G2 to the focal length of the third lens group G3. By satisfying Conditional Expression (3), it is possible to obtain favorable optical performance while achieving size and weight reduction of the optical system OL. When the upper limit value of Conditional Expression (3) is exceeded, the focal length of the third lens group G3 is short, in other words, the refractive power of the third lens group G3 is too strong, which makes it difficult to correct spherical aberration in the telephoto end state and thus such a configuration is not preferable. Meanwhile, it is possible to secure the advantageous effect of the present embodiment more surely by setting the upper limit value of Conditional Expression (3) to 1.500. Further, in order to secure the advantageous effect of the present embodiment further more surely, it is preferable to set the upper limit value of Conditional Expression (3) to 1.300. Moreover, when the lower limit value of Conditional Expression (3) is exceeded, the focal length of the second lens group G2 is short, in other words, the refractive power of the second lens group G2 is too strong, which makes it difficult to correct spherical aberration in the telephoto end state and thus such a configuration is not preferable. Moreover, it is possible to secure the advantageous effect of the present embodiment more surely by setting the lower limit value of Conditional Expression (3) to 0.600. Further, in order to secure the advantageous effect of the present embodiment further more surely, it is preferable to set the lower limit value of Conditional Expression (3) to 0.700.

Moreover, the optical system OL according to the present embodiment preferably satisfies Conditional Expression (4) shown below.

$$0.4 < f 2 / f 4 < 2. \qquad ( 4 )$$

in the expression,
f2: focal length of the second lens group G2, and
f4: focal length of the fourth lens group G4.

Conditional Expression (4) defines the ratio of the focal length of the second lens group G2 to the focal length of the fourth lens group G4. By satisfying Conditional Expression (4), it is possible to obtain favorable optical performance while achieving size and weight reduction of the optical system OL. When the upper limit value of Conditional Expression (4) is exceeded, the focal length of the fourth lens group G4 is short, in other words, the refractive power of the fourth lens group G4 is too strong, which makes it difficult to correct spherical aberration in the telephoto end state and thus such a configuration is not preferable. Meanwhile, it is possible to secure the advantageous effect of the present embodiment more surely by setting the upper limit value of Conditional Expression (4) to 1.000. Further, in order to secure the advantageous effect of the present embodiment further more surely, it is preferable to set the upper limit value of Conditional Expression (4) to 0.800. Moreover, when the lower limit value of Conditional Expression (4) is exceeded, the focal length of the second lens group G2 is short, in other words, the refractive power of the second lens group G2 is too strong, which makes it difficult to correct spherical aberration in the telephoto end state and thus such a configuration is not preferable. Moreover, it is possible to secure the advantageous effect of the present embodiment more surely by setting the lower limit value of Conditional Expression (4) to 0.470. Further, in order to secure the advantageous effect of the present embodiment further more surely, it is preferable to set the lower limit value of Conditional Expression (4) to 0.490.

Moreover, the optical system OL according to the present embodiment preferably satisfies Conditional Expression (5) shown below.

$$4. < f 1 / ( - f 2 ) < 8. \qquad ( 5 )$$

in the expression,
f1: focal length of the first lens group G1, and
f2: focal length of the second lens group G2.

Conditional Expression (5) defines the ratio of the focal length of the first lens group G1 to the focal length of the second lens group G2. By satisfying Conditional Expression (5), it is possible to obtain favorable optical performance while achieving size and weight reduction of the optical system OL. When the upper limit value of Conditional Expression (5) is exceeded, the refractive power of the second lens group G2 is too strong, and as a result, the refractive power of the fourth lens group G4 is too strong, which makes it difficult to correct spherical aberration in the telephoto end state and thus such a configuration is not preferable. Meanwhile, it is possible to secure the advantageous effect of the present embodiment more surely by setting the upper limit value of Conditional Expression (5) to 7.500. Further, in order to secure the advantageous effect of the present embodiment further more surely, it is preferable to set the upper limit value of Conditional Expression (5) to 7.000. Moreover, when the lower limit value of Conditional Expression (5) is exceeded, the refractive power of the first lens group G1 is too strong, and as a result, the refractive power of the second lens group G2 is too strong, which makes it difficult to correct spherical aberration in the telephoto end state and thus such a configuration is not preferable. Moreover, it is possible to secure the advantageous effect of the present embodiment more surely by setting the lower limit value of Conditional Expression (5) to 4.500. Further, in order to secure the advantageous effect of the present embodiment further more surely, it is preferable to set the lower limit value of Conditional Expression (5) to 5.000.

Moreover, the optical system OL according to the present embodiment preferably satisfies Conditional Expression (6) shown below.

$$0.1 < ( - f 2 ) / f 5 < 0.8 \qquad ( 6 )$$

in the expression,
f2: focal length of the second lens group G2, and
f5: focal length of the fifth lens group G5.

Conditional Expression (6) defines the ratio of the focal length of the second lens group G2 to the focal length of the fifth lens group G5. By satisfying Conditional Expression (6), it is possible to obtain favorable optical performance while achieving size and weight reduction of the optical system OL. When the upper limit value of Conditional Expression (6) is exceeded, the refractive power of the fifth lens group G5 is too strong, and as a result, the refractive power of the third lens group G3 is too strong, which makes it difficult to correct spherical aberration in the telephoto end state and thus such a configuration is not preferable. Meanwhile, it is possible to secure the advantageous effect of the present embodiment more surely by setting the upper limit value of Conditional Expression (6) to 0.500. Further, in order to secure the advantageous effect of the present embodiment further more surely, it is preferable to set the upper limit value of Conditional Expression (6) to 0.400. Moreover, when the lower limit value of Conditional Expression (6) is exceeded, the refractive power of the second lens group G2 is too strong, and as a result, the refractive power of the fifth lens group G5 is too strong, which makes it difficult to correct variation in field curvature at zooming and thus such a configuration is not preferable. Moreover, it is possible to secure the advantageous effect of the present embodiment more surely by setting the lower limit value of Conditional Expression (6) to 0.200. Further, in order to secure the advantageous effect of the present embodiment further more surely, it is preferable to set the lower limit value of Conditional Expression (6) to 0.240.

Moreover, the optical system OL according to the present embodiment preferably satisfies Conditional Expression (7) shown below.

$$0.1 < f 3 / f 5 < 0.48 \qquad ( 7 )$$

in the expression,
f3: focal length of the third lens group G3, and
f5: focal length of the fifth lens group G5.

Conditional Expression (7) defines the ratio of the focal length of the third lens group G3 to the focal length of the fifth lens group G5. By satisfying Conditional Expression (7), it is possible to obtain favorable optical performance while achieving size and weight reduction of the optical system OL. When the upper limit value of Conditional Expression (7) is exceeded, the focal length of the fifth lens group G5 is short, in other words, the refractive power of the fifth lens group G5 is too strong, which makes it difficult to correct variation in field curvature at zooming and thus such a configuration is not preferable. Meanwhile, it is possible to secure the advantageous effect of the present embodiment more surely by setting the upper limit value of Conditional Expression (7) to 0.420. Further, in order to secure the advantageous effect of the present embodiment further more surely, it is preferable to set the upper limit value of Conditional Expression (7) to 0.400. Moreover, when the lower limit value of Conditional Expression (7) is exceeded, the focal length of the third lens group G3 is short, in other words, the refractive power of the third lens group G3 is too strong, which makes it difficult to correct spherical aberration in the telephoto end state and thus such a configuration is not preferable. Moreover, it is possible to secure the advantageous effect of the present embodiment more surely by setting the lower limit value of Conditional Expression (7) to 0.200. Further, in order to secure the advantageous effect of the present embodiment further more surely, it is preferable to set the lower limit value of Conditional Expression (7) to 0.250.

Moreover, the optical system OL according to the present embodiment preferably satisfies Conditional Expression (8) shown below.

$$4. < f 1 / fw < 8. \qquad ( 8 )$$

in the expression,
fw: overall focal length of the optical system OL at focusing on an infinite distance object in the wide-angle end state, and
f1: focal length of the first lens group G1.

Conditional Expression (8) defines the ratio of the focal length of the first lens group G1 to the overall focal length of the optical system OL in the wide-angle end state. By satisfying Conditional Expression (8), it is possible to obtain favorable optical performance while achieving size and weight reduction of the optical system OL. When the upper limit value of Conditional Expression (8) is exceeded, the focal length of the first lens group G1 is long, and as a result, the refractive power of the third lens group G3 is strong to perform zooming with the third lens group G3, which makes it difficult to correct spherical aberration in the telephoto end state and thus such a configuration is not preferable. Meanwhile, it is possible to secure the advantageous effect of the present embodiment more surely by setting the upper limit value of Conditional Expression (8) to 7.500. Further, in order to secure the advantageous effect of the present embodiment further more surely, it is preferable to set the upper limit value of Conditional Expression (8) to 7.000. Moreover, when the lower limit value of Conditional Expression (8) is exceeded, the focal length of the first lens group G1 is short, in other words, the refractive power of the first lens group G1 is too strong, which makes it difficult to correct variation in field curvature at zooming and thus such a configuration is not preferable. Moreover, it is possible to secure the advantageous effect of the present embodiment more surely by setting the lower limit value of Conditional Expression (8) to 4.500.

Moreover, in the optical system OL according to the present embodiment, the first lens group G1 is preferably constituted by two lenses. With this configuration, it is possible to obtain favorable optical performance while achieving size and weight reduction of the optical system OL.

Moreover, in the optical system OL according to the present embodiment, the fourth lens group G4 is preferably configured to move along an optical axis at focusing. With this configuration, it is possible to reduce aberration variation at focusing.

Moreover, the optical system OL according to the present embodiment preferably satisfies Conditional Expression (9) shown below.

$$0.1 < ( D 34 t - D 34 w ) / fw < 0.8 \qquad ( 9 )$$

in the expression,
fw: overall focal length of the optical system OL at focusing on an infinite distance object in the wide-angle end state,
D34w: on-axis air space between the third lens group G3 and the fourth lens group G4 at focusing on an infinite distance object in the wide-angle end state, and
D34t: on-axis air space between the third lens group G3 and the fourth lens group G4 at focusing on an infinite distance object in the telephoto end state.

Conditional Expression (9) defines the ratio of the change amount of the on-axis air space between the third lens group G3 and the fourth lens group G4 at zooming from the wide-angle end state to the telephoto end state to the overall focal length of the optical system OL in the wide-angle end state. By satisfying Conditional Expression (9), it is possible to obtain favorable optical performance at focusing. Meanwhile, it is possible to secure the advantageous effect of the present embodiment more surely by setting the upper limit value of Conditional Expression (9) to 0.700. Moreover, it is possible to secure the advantageous effect of the present embodiment more surely by setting the lower limit value of Conditional Expression (9) to 0.300.

Moreover, the optical system OL according to the present embodiment preferably satisfies Conditional Expression (10) shown below.

$$0.8 < \vert f 12 w \vert / fw < 1.5 \qquad ( 10 )$$

in the expression,
fw: overall focal length of the optical system OL at focusing on an infinite distance object in the wide-angle end state, and
f12w: combined focal length of the first lens group G1 and the second lens group G2 at focusing on an infinite distance object in the wide-angle end state.

Conditional Expression (10) defines the ratio of the combined focal length of the first lens group G1 and the second lens group G2 to the overall focal length of the optical system OL in the wide-angle end state. By satisfying Conditional Expression (10), it is possible to obtain favorable optical performance while achieving size and weight reduction of the optical system OL. When the upper limit value of Conditional Expression (10) is exceeded, the combined focal length of a front group constituted by the first lens group G1 and the second lens group G2 in the wide-angle end state is long, in other words, the refractive power of the front group is too weak, which makes it difficult to correct coma aberration in the wide-angle end state and thus such a configuration is not preferable. Meanwhile, it is possible to secure the advantageous effect of the present embodiment more surely by setting the upper limit value of Conditional Expression (10) to 1.300. Further, in order to secure the advantageous effect of the present embodiment further more surely, it is preferable to set the upper limit value of Conditional Expression (10) to 1.250. Moreover, when the lower limit value of Conditional Expression (10) is exceeded, the combined focal length of the front group is short, in other words, the refractive power of the front group is too strong, which makes it difficult to correct distortion aberration in the wide-angle end state and thus such a configuration is not preferable. Moreover, it is possible to secure the advantageous effect of the present embodiment more surely by setting the lower limit value of Conditional Expression (10) to 0.900. Further, in order to secure the advantageous effect of the present embodiment further more surely, it is preferable to set the lower limit value of Conditional Expression (10) to 1.000.

Moreover, the optical system OL according to the present embodiment preferably satisfies Conditional Expression (11) shown below.

$$0.1 < Bfw / fw < 2. \qquad ( 11 )$$

in the expression,
fw: overall focal length of the optical system OL at focusing on an infinite distance object in the wide-angle end state, and
Bfw: back focus (air-conversion length) of the optical system OL at focusing on an infinite distance object in the wide-angle end state.

Conditional Expression (11) defines the ratio of the back focus to the overall focal length of the optical system OL in the wide-angle end state. By satisfying Conditional Expression (11), it is possible to obtain favorable optical performance while achieving size and weight reduction of the optical system OL. Meanwhile, it is possible to secure the advantageous effect of the present embodiment more surely by setting the upper limit value of Conditional Expression (11) to 1.200. Further, in order to secure the advantageous effect of the present embodiment further more surely, it is preferable to set the upper limit value of Conditional Expression (11) to 1.000. Moreover, it is possible to secure the advantageous effect of the present embodiment more surely by setting the lower limit value of Conditional Expression (11) to 0.500. Further, in order to secure the advantageous effect of the present embodiment further more surely, it is preferable to set the lower limit value of Conditional Expression (11) to 0.600.

Moreover, in the optical system OL according to the present embodiment, at least part of the third lens group G3 is preferably an anti-vibration group Gvr that moves with a component in a direction perpendicular to the optical axis. With this configuration, it is possible to obtain favorable optical performance while achieving size and weight reduction of the optical system OL.

Moreover, the optical system OL according to the present embodiment preferably satisfies Conditional Expression (12) shown below.

$$1. < \vert fvr \vert / f 3 < 6. \qquad ( 12 )$$

in the expression,
f3: focal length of the third lens group G3, and
fvr: focal length of the anti-vibration group Gvr.

Conditional Expression (12) defines the ratio of the focal length of the anti-vibration group Gvr to the focal length of the third lens group G3. By satisfying Conditional Expression (12), it is possible to obtain favorable optical performance while achieving size and weight reduction of the optical system OL. Meanwhile, it is possible to secure the advantageous effect of the present embodiment more surely by setting the upper limit value of Conditional Expression (12) to 3.000. Moreover, it is possible to secure the advantageous effect of the present embodiment more surely by setting the lower limit value of Conditional Expression (12) to 1.300.

Moreover, the optical system OL according to the present embodiment preferably satisfies Conditional Expression (13) shown below.

$$0.2 < ( D 23 w / TLw ) \times ( ft / fw ) < 1.5 \qquad ( 13 )$$

in the expression,
fw: overall focal length of the optical system OL at focusing on an infinite distance object in the wide-angle end state,
ft: overall focal length of the optical system OL at focusing on an infinite distance object in the telephoto end state,
TLw: optical total length of the optical system OL at focusing on an infinite distance object in the wide-angle end state, and
D23w: on-axis air space between the second lens group G2 and the third lens group G3 at focusing on an infinite distance object in the wide-angle end state.

Conditional Expression (13) defines the relation between the ratio of optical total length of the optical system OL and the on-axis air space between the second lens group G2 and the third lens group G3 in the wide-angle end state and the zooming ratio of the optical system OL. By satisfying Conditional Expression (13), it is possible to excellently correct spherical aberration and field curvature from the wide-angle end state to the telephoto end state. Meanwhile, it is possible to secure the advantageous effect of the present embodiment more surely by setting the upper limit value of Conditional Expression (13) to 1.200. Moreover, it is possible to secure the advantageous effect of the present embodiment more surely by setting the lower limit value of Conditional Expression (13) to 0.300.

Moreover, in the optical system OL according to the present embodiment, the fifth lens group G5 preferably includes an aspheric lens (hereinafter referred to as a “specific aspheric lens Las”) having an inflection point and satisfies Conditional Expression (14) shown below.

$$0. < fw / \vert fg 5 as \vert < 0.5 \qquad ( 14 )$$

in the expression,
fw: overall focal length of the optical system OL at focusing on an infinite distance object in the wide-angle end state, and
fg5as: focal length of the specific aspheric lens Las included in the fifth lens group G5.

Conditional Expression (14) defines the ratio of the overall focal length of the optical system OL in the wide-angle end state to the focal length of the aspheric lens (specific aspheric lens Las) having an inflection point and included in the fifth lens group G5. By disposing the aspheric lens (specific aspheric lens Las) having an inflection point and satisfying Conditional Expression (14) in the fifth lens group G5, it is possible to excellently correct spherical aberration and field curvature from the wide-angle end state to the telephoto end state. Meanwhile, it is possible to secure the advantageous effect of the present embodiment more surely by setting the upper limit value of Conditional Expression (14) to 0.300.

Moreover, the optical system OL according to the present embodiment preferably satisfies Conditional Expression (15) shown below.

$$30. ° < ω w < 60. ° \qquad ( 15 )$$

in the expression,
ωw: half angle of view of the optical system OL in the wide-angle end state.

Conditional Expression (15) defines an appropriate range of the half angle of view of the optical system OL in the wide-angle end state. By satisfying Conditional Expression (15), it is possible to obtain favorable optical performance while achieving size and weight reduction of the optical system OL. Meanwhile, it is possible to secure the advantageous effect of the present embodiment more surely by setting the upper limit value of Conditional Expression (15) to 50.00°. Moreover, it is possible to secure the advantageous effect of the present embodiment more surely by setting the lower limit value of Conditional Expression (15) to 42.00°. Further, in order to secure the advantageous effect of the present embodiment further more surely, it is preferable to set the lower limit value of Conditional Expression (15) to 43.00°.

Moreover, the optical system OL according to the present embodiment can reduce the size of the first lens group G1 by moving the first lens group G1 at zooming and can also reduce drive power that is necessary for moving the lens groups at zooming by fixing two of the five lens groups relative to an image plane I at zooming.

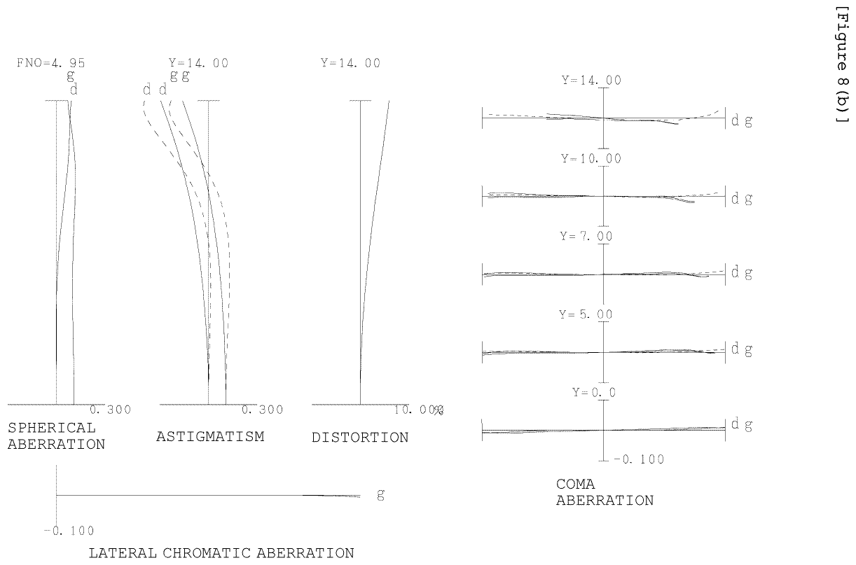

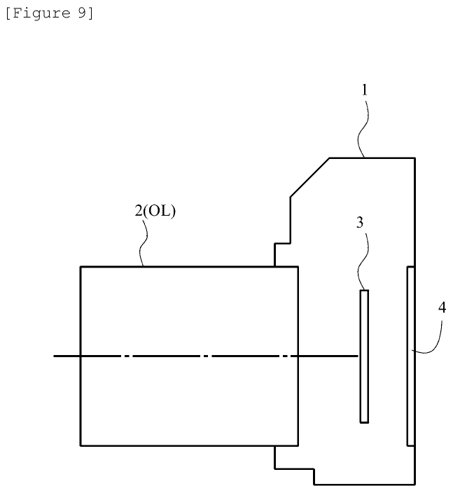

Subsequently, a camera that is an optical apparatus including the optical system OL according to the present embodiment will be described below with reference to FIG. 9. This camera 1 is what is called a mirrorless interchangeable lens camera including the optical system OL according to the present embodiment as an image pickup lens 2. In the camera 1, light from a non-shown object (subject) is condensed through the image pickup lens 2 and forms a subject image on the image surface of an image unit 3 through a non-shown optical low pass filter (OLPF). Then, the subject image is photoelectrically converted by a photoelectric conversion element (image sensor) provided in the image unit 3 and an image of the subject is generated. The image is displayed on an electronic view finder (EVF) 4 provided in the camera 1. Accordingly, a photographer can observe the subject through the EVF 4.

When a non-shown release button is pressed by the photographer, the image photoelectrically converted by the image unit 3 is stored in a non-shown memory. In this manner, the photographer can perform image capturing of the subject with the camera 1. Meanwhile, although the example of a mirrorless camera is described in the present embodiment, it is possible to achieve the same effects as those of the camera 1 described above when the optical system OL according to the present embodiment is mounted on a single-lens reflex camera that includes a quick return mirror in a camera body and with which a subject is observed through a finder optical system.

The contents described below are employable as appropriate to the extent that the optical performance is not compromised.

In the present embodiment, the optical system OL having a five-group configuration is shown, and such configurations, conditions, and the like are also applicable to any other group configuration such as a six-group configuration or a seven-group configuration. Further, the optical system OL may instead have a configuration in which a lens or a lens group closest to the object side is added or a configuration in which a lens or a lens group closest to the image plane side is added. Specifically, such a configuration is a configuration in which a lens group having a position fixed relative to the image plane at zooming and focusing is added closest to the image plane side. A lens group means a part including at least one lens and separated by an air space that changes at zooming and focusing as long as no boundary is designated. A lens component means a single lens or a cemented lens obtained by cementing a plurality of lenses.

A focusing group may be a single lens group, a plurality of lens groups, or a partial lens group moved in the optical axis direction to focus on from an infinite distance object to a close distance object. In this case, the focusing group can also be used to perform autofocusing and is suitably driven by a motor for autofocusing (such as an ultrasonic wave motor). In particular, the focusing group is preferably the fourth lens group G4, and any other lens preferably has a position fixed relative to the image plane at focusing.

An anti-vibration group may be a lens group or a partial lens group moved with a displacement component in the direction perpendicular to the optical axis or rotated (swung) in an in-plane direction containing the optical axis to correct an image blur caused by a camera shake. In particular, the anti-vibration group is preferably at least part of the third lens group G3.

A lens surface may be so formed as to be a spherical surface, a flat surface, or an aspheric surface. In the case where a lens surface is a spherical or flat surface, the lens is readily processed, assembled, and adjusted, whereby degradation in the optical performance due to errors in the lens processing, assembly, and adjustment is preferably avoided. Further, even when an image plane is shifted, the amount of degradation in drawing performance is preferably small. In the case where the lens surface is an aspheric surface, the aspheric surface may be any of a ground aspheric surface, a glass molded aspheric surface that is a glass surface so molded in a die as to have an aspheric shape, and a composite aspheric surface that is a glass surface on which aspherically shaped resin is formed. The lens surface may instead be a diffractive surface, or the lenses may be any of a distributed index lens (GRIN lens) or a plastic lens.

An aperture stop S is preferably disposed on the object side of the third lens group G3. No member as an aperture stop may be provided, and the frame of a lens may serve as the aperture stop.

Further, each lens surface may be provided with an antireflection coating having high transmittance over a wide wavelength range to achieve good optical performance that reduces flare and ghost and achieves high contrast.

Moreover, a zooming optical system ZL of the present embodiment has a zooming ratio of approximately 2 to 5 times.

Note that conditions and configurations described above each achieve an above-described effect, and not all configurations and conditions necessarily need to be satisfied but the above-described effect can be obtained with either conditions or configurations or with either combination of conditions or configurations.

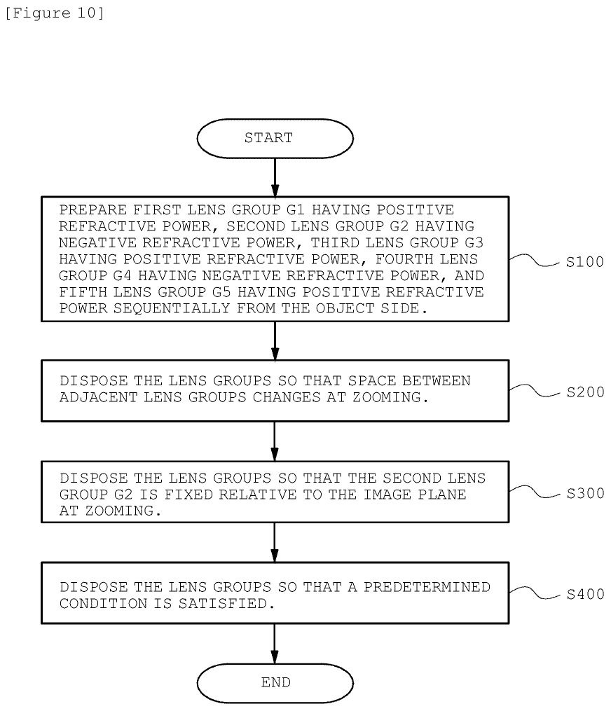

A method for manufacturing the optical system OL according to the first embodiment will be schematically described below with reference to FIG. 10. First, a first lens group G1 having positive refractive power, a second lens group G2 having negative refractive power, a third lens group G3 having positive refractive power, a fourth lens group G4 having negative refractive power, and a fifth lens group G5 having positive refractive power are prepared sequentially from the object side (step S100). Subsequently, the lens groups are disposed so that the space between adjacent lens groups changes at zooming (step S200), and the lens groups are disposed so that the second lens group G2 is fixed relative to the image plane at zooming (step S300). Then, the lens groups are disposed so that a predetermined condition (for example, Conditional Expression (1) described above) is satisfied (step S400).

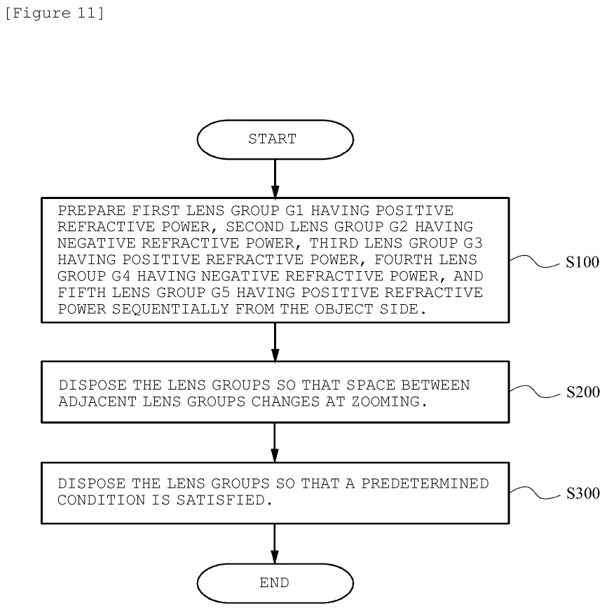

A method for manufacturing the optical system OL according to the second embodiment will be schematically described below with reference to FIG. 11. First, a first lens group G1 having positive refractive power, a second lens group G2 having negative refractive power, a third lens group G3 having positive refractive power, a fourth lens group G4 having negative refractive power, and a fifth lens group G5 having positive refractive power are prepared sequentially from the object side (step S100). Subsequently, the lens groups are disposed so that the space between adjacent lens groups changes at zooming (step S200). Then, the lens groups are disposed so that a predetermined condition (for example, Conditional Expressions (1) and (2) described above) is satisfied (step S300).

In this manner, an optical system that can obtain favorable optical performance while achieving size and weight reduction, an optical apparatus, and a method for manufacturing the optical system can be provided.

### EXAMPLES

Examples will be described below with reference to the accompanying drawings. Note that FIGS. 1, 3, 5, and 7 are cross-sectional views showing the configurations of optical systems OL (OL1 to OL4) according to the examples and the refractive power distribution thereof. In the cross-sectional views of the optical systems OL1 to OL4, arrows show the moving directions of the lens groups along the optical axis at zooming from the wide-angle end state (W) to the telephoto end state (T) and at focusing on from an infinite distance object (∞) to a close distance object.

In the examples, each aspheric surface is expressed by Expression (a) below, where y represents the height in a direction perpendicular to the optical axis, S(y) represents the distance (sag amount) on the optical axis from a tangent plane at the apex of the aspheric surface at the height y to the aspheric surface, r represents the radius of curvature (paraxial radius of curvature) of a reference spherical surface, K represents the conic constant, and An represents the n-th aspheric surface coefficient. Note that, in the examples below, “E-n” represents “×10⁻ⁿ”.

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} \qquad ( a )$$

Note that, in the examples, the second aspheric surface coefficient A2 is zero. In tables of the examples, the symbol “*” is attached on the right side of the surface number of an aspheric surface.

### First Example

FIG. 1 is a diagram showing the configuration of the optical system OL1 according to a first example. The optical system OL1 includes, sequentially from the object side, a first lens group G1 having positive refractive power, a second lens group G2 having negative refractive power, a third lens group G3 having positive refractive power, a fourth lens group G4 having negative refractive power, and a fifth lens group G5 having positive refractive power.

The first lens group G1 is constituted by one lens component and includes a cemented positive lens formed by cementing a negative lens L11 in a meniscus shape having a convex surface facing the object side and a positive lens L12 in a meniscus shape having a convex surface facing the object side sequentially from the object side. The second lens group G2 includes, sequentially from the object side, a negative lens L21 in a meniscus shape formed with an aspheric lens surface on the object side and having a convex surface facing the object side, a biconcave negative lens L22, a biconvex positive lens L23, and a negative lens L24 in a meniscus shape having a concave surface facing the object side. The third lens group G3 includes, sequentially from the object side, a biconvex positive lens L31, a cemented negative lens formed by cementing a biconvex positive lens L32 and a biconcave negative lens L33, a positive lens L34 in a meniscus shape having a convex surface facing the object side, a cemented negative lens formed by cementing a positive lens L35 in a meniscus shape having a concave surface facing the object side and a biconcave negative lens L36, and a biconvex positive lens L37 formed with an aspheric lens surface on the object side and an aspheric lens surface on the image plane side. The fourth lens group G4 includes a biconcave negative lens L41 formed with an aspheric lens surface on the image plane side. The fifth lens group G5 includes, sequentially from the object side, a positive lens L51 (specific aspheric lens Las) in a meniscus shape formed with an aspheric lens surface on the object side and an aspheric lens surface on the image plane side and having a concave surface facing the object side near the optical axis, and a positive lens L52 in a meniscus shape having a concave surface facing the object side.

In the optical system OL1, the space between adjacent lens groups changes at zooming from the wide-angle end state to the telephoto end state. Moreover, in the optical system OL1, at zooming from the wide-angle end state to the telephoto end state, the second lens group G2 and the fifth lens group G5 are fixed relative to the image plane I, and the first lens group G1, the third lens group G3, and the fourth lens group G4 move to the object side along the optical axis.

In the optical system OL1, the fourth lens group G4 moves to the image plane side at focusing on from an infinite distance object to a close distance object.

In the optical system OL1, the aperture stop S is disposed between the second lens group G2 and the third lens group G3 (on the object side of the third lens group G3) and moves along the optical axis together with the third lens group G3 at zooming.

In the optical system OL1, image position correction (anti-vibration) when camera shake occurs is performed by moving, as an anti-vibration lens group Gvr, the cemented negative lens formed by cementing the positive lens L35 and the negative lens L36 in the third lens group G3, with a displacement component in the direction perpendicular to the optical axis.

Table 1 below shows values of specifications of the optical system OL1. In Table 1, the following specifications shown as overall specifications are defined as follows: f represents the overall focal length; FNO represents the F number; ω represents the half angle of view [°]; Y represents the maximum image height; TL represents the optical total length; and BF represents values of the back focus at focusing on an infinite distance object in the wide-angle end state, an intermediate focal length state, and the telephoto end state. The back focus BF represents the distance in air-conversion length on the optical axis from the lens surface (thirtieth surface) closest to the image plane side to the image plane I. The optical total length TL represents a length obtained by adding the back focus in air-conversion length to the distance on the optical axis from the lens surface (first surface) closest to the object side to the lens surface (thirtieth surface) closest to the image plane side. Note that, in lens data, a first field m shows the sequence of lens surfaces (surface numbers) counted from the object side in a direction in which a ray travels, a second field r shows the radius of curvature of each lens surface, a third field d shows the distance (inter-surface distance) on the optical axis from each optical surface to the next optical surface, and a fourth field nd and a fifth field νd show the refractive index and the Abbe number at the d line (2=587.6 nm). A radius of curvature ∞ represents a flat surface, and the refractive index of air, which is 1.00000, is omitted. The lens group focal length shows the surface number of the first surface and the focal length of each lens group.

The unit of each of the focal length f, the radius of curvature r, the inter-surface distance d, and other lengths shown in all the variety of specifications below is typically “mm”, but not limited to this, because an optical system provides the same optical performance even when the optical system is proportionally enlarged or reduced. The above description of symbols and specification tables applies to subsequent examples as well.

TABLE 1
First example

| | | Intermediate | Telephoto |
|---|---|---|---|
| | Wide-angle | focal | end |
| [Overall specifications] | end state | length state | state |
| f = | 16.501~ | 34.996~ | 67.795 |
| FNO = | 2.890~ | 4.004~ | 4.826 |
| ω [°] = | 43.2451~ | 22.106~ | 11.546 |
| Y = | 14.000~ | 14.750~ | 14.750 |
| TL (air-conversion length) = | 86.003~ | 97.716~ | 116.000 |
| BF (air-conversion length) = | 11.962~ | 11.952~ | 11.938 |

| [Lens data] | | | | |
|---|---|---|---|---|
| m | r | d | nd | νd |
| Object plane | ∞ | D0 | | |
| 1 | 54.2699 | 1.2000 | 1.75520 | 27.57 |
| 2 | 36.9813 | 6.1652 | 1.59349 | 67.00 |
| 3 | 2549.7300 | D3 | | |
| 4* | 183.4910 | 0.8000 | 1.80901 | 45.97 |
| 5 | 13.3026 | 5.0739 | | |
| 6 | −44.3283 | 0.8000 | 1.88300 | 40.66 |
| 7 | 68.7802 | 0.1000 | | |
| 8 | 30.6344 | 3.7679 | 1.82364 | 24.66 |
| 9 | −31.0439 | 1.0850 | | |
| 10 | −19.4153 | 0.8000 | 1.88300 | 40.66 |
| 11 | −49.7999 | D11 | | |
| 12 | ∞ | 0.1000 | | Aperture stop S |
| 13 | 19.1863 | 2.7152 | 1.77250 | 49.62 |
| 14 | −107.0550 | 0.9303 | | |
| 15 | 14.8387 | 3.6516 | 1.67792 | 51.28 |
| 16 | −24.6230 | 0.8000 | 1.82834 | 33.25 |
| 17 | 9.4095 | 0.1041 | | |
| 18 | 9.8011 | 2.5502 | 1.52831 | 66.40 |
| 19 | 43.2667 | 0.9914 | | |
| 20 | −88.8445 | 2.5332 | 1.84666 | 23.80 |
| 21 | −11.5268 | 0.8000 | 1.79355 | 30.61 |
| 22 | 31.4782 | 0.9785 | | |
| 23* | 14.6850 | 2.7193 | 1.48749 | 70.40 |
| 24* | −29.5678 | D24 | | |
| 25 | −45.7567 | 0.8000 | 1.62041 | 60.32 |
| 26* | 22.1505 | D26 | | |
| 27* | −102.1710 | 2.8468 | 1.53113 | 55.75 |
| 28* | −32.2197 | 1.5003 | | |
| 29 | −87.5129 | 2.0990 | 1.48749 | 70.40 |
| 30 | −43.2655 | BF | | |
| Image plane | ∞ | | | |

| [Focal length of lens groups] | First | Focal |
|---|---|---|
| Lens group | surface | length |
| First lens group G1 | 1 | 106.808 |
| Second lens group G2 | 4 | −15.411 |
| Third lens group G3 | 13 | 17.324 |
| Fourth lens group G4 | 25 | −23.949 |
| Fifth lens group G5 | 27 | 58.804 |

In the optical system OL1, the fourth surface, the twenty-third surface, the twenty-fourth surface, the twenty-sixth surface, the twenty-seventh surface, and the twenty-eighth surface are formed in aspheric shapes. Table 2 below shows aspheric surface data, in other words, the values of the conic constant K and the aspheric surface constants A4 to A10 for the surface number m.

TABLE 2

| m | K | A4 | A6 | A8 | A10 |
|---|---|---|---|---|---|
| 4 | 1.0000 | 7.00000E−06 | −1.49968E−08 | 2.60606E−11 | 2.15948E−13 |
| 23 | 1.0000 | −9.90000E−05 | −2.38813E−07 | 2.54537E−09 | 0.00000E+00 |
| 24 | 1.0000 | 6.10000E−05 | 0.00000E+00 | 0.00000E+00 | 0.00000E+00 |
| 26 | 1.0000 | 6.30000E−05 | −3.66639E−07 | 6.57790E−10 | 0.00000E+00 |
| 27 | 1.0000 | 6.90000E−05 | 0.00000E+00 | 0.00000E+00 | 0.00000E+00 |
| 28 | 1.0000 | 5.80000E−05 | 4.37301E−08 | 4.89129E−12 | 0.00000E+00 |

In the optical system OL1, an on-axis air space D3 between the first lens group G1 and the second lens group G2, an on-axis air space D11 between the second lens group G2 and the aperture stop S, an on-axis air space D24 between the third lens group G3 and the fourth lens group G4, an on-axis air space D26 between the fourth lens group G4 and the fifth lens group G5, and the back focus BF change at zooming. Table 3 below shows variable spaces in the wide-angle end state, the intermediate focal length state, and the telephoto end state at focusing on an infinite distance object and at focusing on a close distance object. Note that DO represents the distance from the lens surface (first surface) closest to the object side in the optical system OL1 to the object, f represents the focal length, and β represents the image pickup magnification. This description applies to subsequent examples as well.

TABLE 3
[Variable space data]

| | Focusing on infinite distance object | | | Focusing on close distance object | | |
|---|---|---|---|---|---|---|
| | Wide angle | Intermediate | Telephoto | Wide angle | Intermediate | Telephoto |
| f | 16.501 | 34.996 | 67.795 | — | — | — |
| β | — | — | — | 0.1240 | 0.1044 | 0.1231 |
| D0 | ∞ | ∞ | ∞ | 113.9910 | 302.2760 | 484.0010 |
| D3 | 1.4744 | 13.1923 | 31.4675 | 1.4744 | 13.1923 | 31.4675 |
| D11 | 20.7295 | 8.6922 | 1.4859 | 20.7295 | 8.6922 | 1.4859 |
| D24 | 1.4958 | 4.6674 | 10.0138 | 2.3922 | 5.8554 | 12.6766 |
| D26 | 4.3924 | 13.2544 | 15.1196 | 3.4876 | 12.0718 | 12.4577 |
| BF | 11.9620 | 11.9522 | 11.9375 | 12.3144 | 12.1980 | 12.2813 |

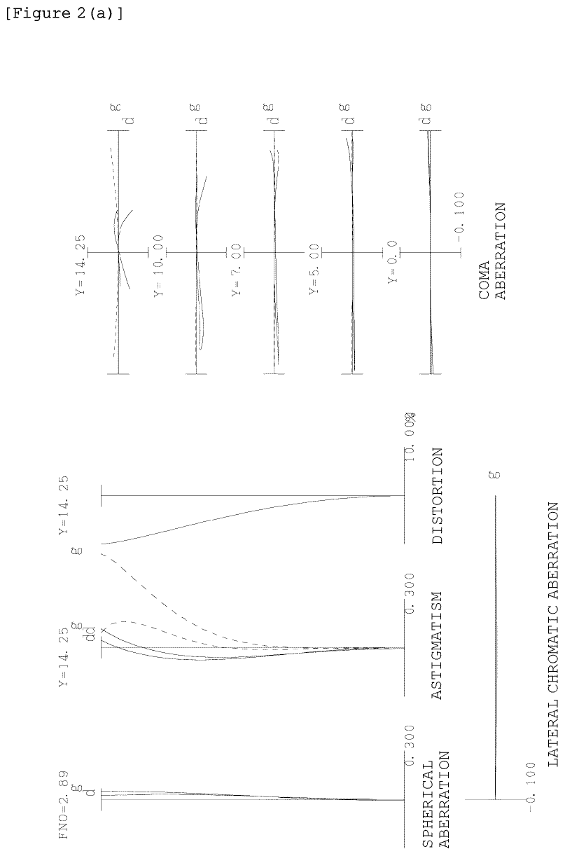

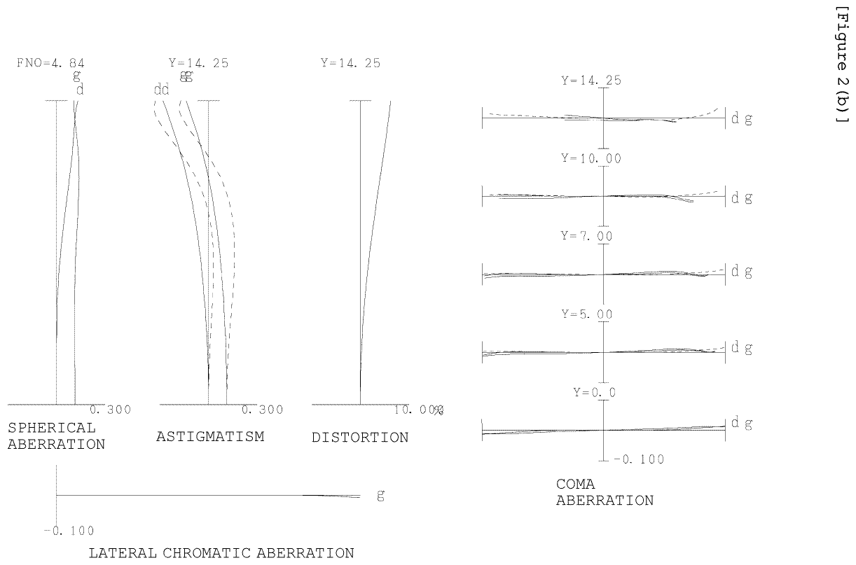

FIG. 2 shows a spherical aberration diagram, an astigmatism diagram, a distortion diagram, a lateral chromatic aberration diagram, and a coma aberration diagram of the optical system OL1 at focusing on an infinite distance object. Note that, in FIG. 2, (a) shows the wide-angle end state and (b) shows the telephoto end state. In each aberration diagram, FNO represents the F number, and Y represents the image height. Note that the spherical aberration diagram shows the value of the F number corresponding to the maximum diameter, the astigmatism diagram and the distortion diagram each show the maximum value of the image height, and the coma aberration diagram shows the value of each image height. In addition, reference character d represents the d-line (λ=587.6 nm), and g represents the g-line (λ=435.8 nm). In the astigmatism diagram and the coma aberration diagram, the solid line represents the sagittal image plane, and the dashed line represents the meridional image plane. Further, in the aberration diagrams in the following examples, the same reference characters as those in the present example are used. The aberration diagrams show that the optical system OL1 allows favorable correction of the variety of aberrations and has excellent imaging performance.

### Second Example

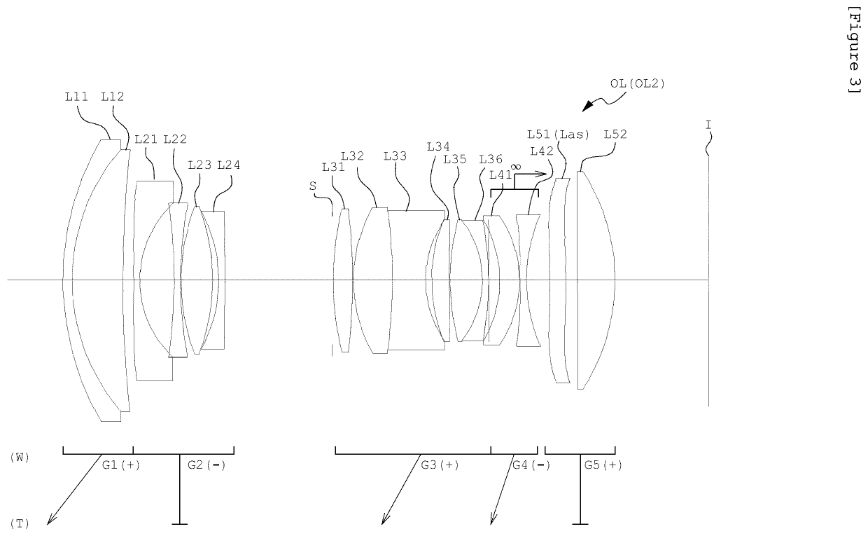

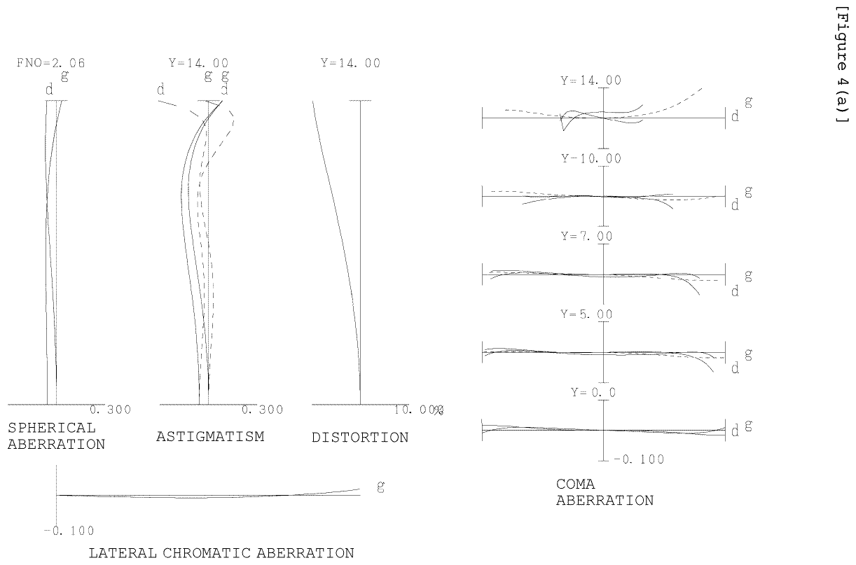

FIG. 3 is a diagram showing the configuration of the optical system OL2 according to a second example. The optical system OL2 includes, sequentially from the object side, a first lens group G1 having positive refractive power, a second lens group G2 having negative refractive power, a third lens group G3 having positive refractive power, a fourth lens group G4 having negative refractive power, and a fifth lens group G5 having positive refractive power.

The first lens group G1 is constituted by one lens component and includes a cemented positive lens formed by cementing a negative lens L11 in a meniscus shape having a convex surface facing the object side and a positive lens L12 in a meniscus shape having a convex surface facing the object side sequentially from the object side. The second lens group G2 includes, sequentially from the object side, a negative lens L21 in a meniscus shape formed with an aspheric lens surface on the object side and having a convex surface facing the object side, a biconcave negative lens L22, a biconvex positive lens L23, and a negative lens L24 in a meniscus shape having a concave surface facing the object side. The third lens group G3 includes, sequentially from the object side, a biconvex positive lens L31, a cemented negative lens formed by cementing a biconvex positive lens L32 and a biconcave negative lens L33, a positive lens L34 in a meniscus shape having a convex surface facing the object side, and a cemented positive lens formed by cementing a biconvex positive lens L35 and a negative lens L36 in a meniscus shape having a concave surface facing the object side. The fourth lens group G4 includes, sequentially from the object side, a positive lens L41 in a meniscus shape having a concave surface facing the object side, and a biconcave negative lens L42 formed with an aspheric lens surface on the object side. The fifth lens group G5 includes, sequentially from the object side, a positive lens L51 (specific aspheric lens Las) in a meniscus shape formed with an aspheric lens surface on the object side and an aspheric lens surface on the image plane side and having a concave surface facing the object side near the optical axis, and a positive lens L52 in a meniscus shape having a concave surface facing the object side.

In the optical system OL2, the space between adjacent lens groups changes at zooming from the wide-angle end state to the telephoto end state. Moreover, in the optical system OL2, at zooming from the wide-angle end state to the telephoto end state, the second lens group G2 and the fifth lens group G5 are fixed relative to the image plane I, and the first lens group G1, the third lens group G3, and the fourth lens group G4 move to the object side along the optical axis.

In the optical system OL2, the fourth lens group G4 moves to the image plane side at focusing on from an infinite distance object to a close distance object.

In the optical system OL2, the aperture stop S is disposed between the second lens group G2 and the third lens group G3 (on the object side of the third lens group G3) and moves along the optical axis together with the third lens group G3 at zooming.

Table 4 below shows values of specifications of the optical system OL2. Note that, in Table 4 below and FIG. 3, the twenty-third surface is a virtual surface.

TABLE 4
Second example

| | | Intermediate | Telephoto |
|---|---|---|---|
| | Wide-angle | focal | end |
| [Overall specifications] | end state | length state | state |
| f = | 16.508~ | 34.989~ | 48.349 |
| FNO = | 2.060~ | 2.691~ | 2.881 |
| ω [°] = | 43.266~ | 21.704~ | 15.800 |
| Y = | 14.000~ | 14.750~ | 14.750 |
| TL (air-conversion length) = | 83.011~ | 95.723~ | 104.772 |
| BF (air-conversion length) = | 12.053~ | 12.035~ | 12.025 |

| [Lens data] | | | | |
|---|---|---|---|---|
| m | r | d | nd | νd |
| Object plane | ∞ | D0 | | |
| 1 | 35.4862 | 1.2000 | 1.75520 | 27.57 |
| 2 | 25.5834 | 6.5385 | 1.59349 | 67.00 |
| 3 | 152.3090 | D3 | | |
| 4* | 1689.4100 | 0.8000 | 1.88300 | 40.66 |
| 5 | 13.5661 | 4.3959 | | |
| 6 | −68.7783 | 0.8000 | 1.86503 | 30.27 |
| 7 | 51.0222 | 0.1000 | | |
| 8 | 26.5459 | 4.0548 | 1.84666 | 23.80 |
| 9 | −26.4139 | 0.7792 | | |
| 10 | −18.4622 | 0.8000 | 1.77250 | 49.62 |
| 11 | −383.8030 | D11 | | |
| 12 | ∞ | 0.1000 | | Aperture stop S |
| 13 | 37.5962 | 2.5142 | 1.74397 | 44.85 |
| 14 | −72.5147 | 0.1000 | | |
| 15 | 18.8636 | 5.0000 | 1.68416 | 50.54 |
| 16 | −66.2771 | 4.2700 | 1.75308 | 27.67 |
| 17 | 13.6067 | 0.8034 | | |
| 18 | 20.9080 | 2.2713 | 1.73824 | 45.30 |
| 19 | 754.6970 | 0.1000 | | |
| 20 | 31.5360 | 4.1108 | 1.62041 | 60.32 |
| 21 | −12.5779 | 0.8000 | 1.74870 | 35.42 |
| 22 | −40.0126 | 0.0000 | | |
| 23 | ∞ | D23 | | |
| 24 | −15.1914 | 2.5380 | 1.75520 | 27.58 |
| 25 | −14.5811 | 0.1000 | | |
| 26* | −198.8330 | 0.8000 | 1.74397 | 44.85 |
| 27 | 20.7828 | D27 | | |
| 28* | −76.3803 | 2.0474 | 1.53113 | 55.75 |
| 29* | −75.9482 | 1.4827 | | |
| 30 | −2524.4300 | 4.8349 | 1.62041 | 60.32 |
| 31 | −25.6830 | BF | | |
| Image plane | ∞ | | | |

| [Focal length of lens groups] | First | Focal |
|---|---|---|
| Lens group | surface | length |
| First lens group G1 | 1 | 87.311 |
| Second lens group G2 | 4 | −13.812 |
| Third lens group G3 | 13 | 15.803 |
| Fourth lens group G4 | 24 | −27.379 |
| Fifth lens group G5 | 28 | 41.247 |

In the optical system OL2, the fourth surface, the twenty-sixth surface, the twenty-eighth surface, and the twenty-ninth surface are formed in aspheric shapes. Table 5 below shows aspheric surface data, in other words, the values of the conic constant K and the aspheric surface constants A4 to A10 for the surface number m.

TABLE 5

| m | K | A4 | A6 | A8 | A10 |
|---|---|---|---|---|---|
| 4 | 1.0000 | 1.00000E−05 | 4.89024E−08 | −4.86373E−10 | 2.00783E−12 |
| 26 | 1.0000 | −8.50000E−05 | −3.36913E−08 | 2.22391E−09 | 0.00000E+00 |
| 28 | 1.0000 | 6.70000E−05 | 0.00000E+00 | 0.00000E+00 | 0.00000E+00 |
| 29 | 1.0000 | 5.40000E−05 | −3.41328E−08 | 2.22275E−10 | 0.00000E+00 |

In the optical system OL2, an on-axis air space D3 between the first lens group G1 and the second lens group G2, an on-axis air space D11 between the second lens group G2 and the aperture stop S, an on-axis air space D23 between the third lens group G3 and the fourth lens group G4, an on-axis air space D27 between the fourth lens group G4 and the fifth lens group G5, and the back focus BF change at zooming. Table 6 below shows variable spaces in the wide-angle end state, the intermediate focal length state, and the telephoto end state at focusing on an infinite distance object and at focusing on a close distance object.

TABLE 6
[Variable space data]

| | Focusing on infinite distance object | | | Focusing on close distance object | | |
|---|---|---|---|---|---|---|
| | Wide angle | Intermediate | Telephoto | Wide angle | Intermediate | Telephoto |
| f | 16.508 | 34.989 | 48.349 | — | — | — |
| β | — | — | — | 0.1211 | 0.1026 | 0.0878 |
| D0 | ∞ | ∞ | ∞ | 117.4290 | 304.7930 | 495.8140 |
| D3 | 1.3872 | 14.1029 | 23.0435 | 1.3872 | 14.1029 | 23.0435 |
| D11 | 13.8070 | 4.0782 | 1.4655 | 13.8070 | 4.0782 | 1.4655 |
| D23 | 1.4399 | 5.3389 | 6.9690 | 2.7500 | 7.1823 | 9.0827 |
| D27 | 3.0257 | 8.8266 | 9.8507 | 1.7211 | 7.0111 | 7.7172 |
| BF | 12.0533 | 12.0347 | 12.0252 | 12.0966 | 12.0681 | 12.0669 |

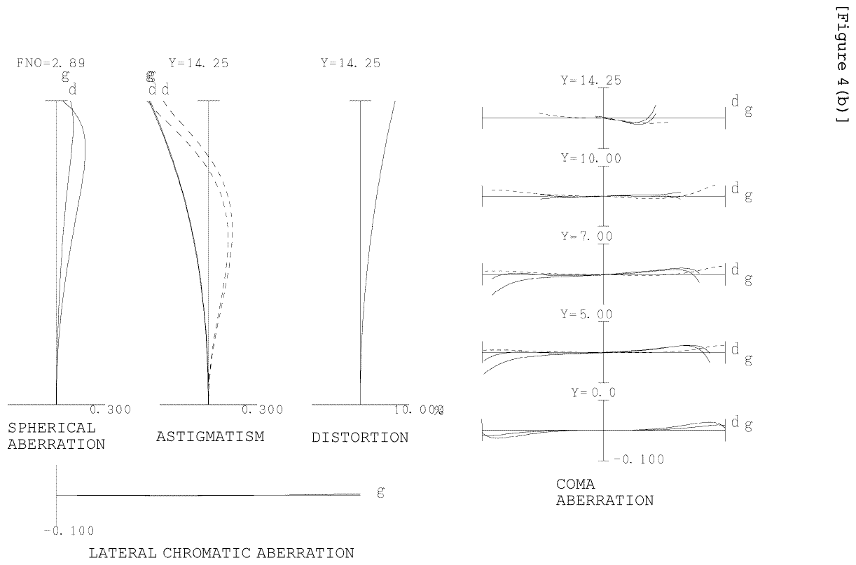

FIG. 4 shows a spherical aberration diagram, an astigmatism diagram, a distortion diagram, a lateral chromatic aberration diagram, and a coma aberration diagram of the optical system OL2 at focusing on an infinite distance object. Note that, in FIG. 4, (a) shows the wide-angle end state and (b) shows the telephoto end state. The aberration diagrams show that the optical system OL2 allows favorable correction of the variety of aberrations and has excellent imaging performance.

### Third Example

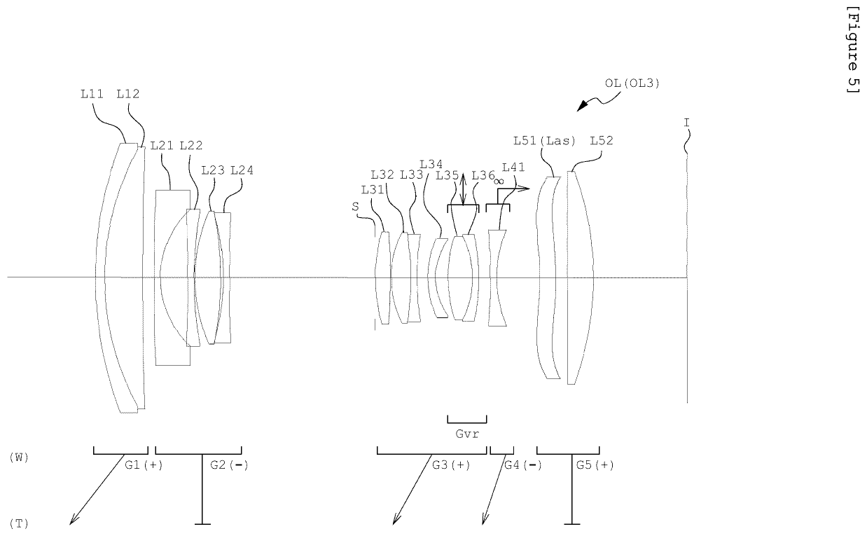

FIG. 5 is a diagram showing the configuration of the optical system OL3 according to a third example. The optical system OL3 includes, sequentially from the object side, a first lens group G1 having positive refractive power, a second lens group G2 having negative refractive power, a third lens group G3 having positive refractive power, a fourth lens group G4 having negative refractive power, and a fifth lens group G5 having positive refractive power.

The first lens group G1 is constituted by one lens component and includes a cemented positive lens formed by cementing a negative lens L11 in a meniscus shape having a convex surface facing the object side and a positive lens L12 in a meniscus shape having a convex surface facing the object side sequentially from the object side. The second lens group G2 includes, sequentially from the object side, a negative lens L21 in a meniscus shape formed with an aspheric lens surface on the object side and having a convex surface facing the object side, a biconcave negative lens L22, a biconvex positive lens L23, and a biconcave negative lens L24. The third lens group G3 includes, sequentially from the object side, a biconvex positive lens L31, a cemented positive lens formed by cementing a biconvex positive lens L32 and a biconcave negative lens L33, a negative lens L34 in a meniscus shape having a convex surface facing the object side, and a cemented positive lens formed by cementing a biconvex positive lens L35 and a negative lens L36 in a meniscus shape having a concave surface facing the object side. The fourth lens group G4 includes a biconcave negative lens L41 formed with an aspheric lens surface on the object side. The fifth lens group G5 includes, sequentially from the object side, a positive lens L51 (specific aspheric lens Las) in a meniscus shape formed with an aspheric lens surface on the object side and an aspheric lens surface on the image plane side and having a concave surface facing the object side near the optical axis, and a biconvex positive lens L52.

In the optical system OL3, the space between adjacent lens groups changes at zooming from the wide-angle end state to the telephoto end state. Moreover, in the optical system OL3, at zooming from the wide-angle end state to the telephoto end state, the second lens group G2 and the fifth lens group G5 are fixed relative to the image plane I, and the first lens group G1, the third lens group G3, and the fourth lens group G4 move to the object side along the optical axis.

In the optical system OL3, the fourth lens group G4 moves to the image plane side at focusing on from an infinite distance object to a close distance object.

In the optical system OL3, the aperture stop S is disposed between the second lens group G2 and the third lens group G3 (on the object side of the third lens group G3) and moves along the optical axis together with the third lens group G3 at zooming.

In the optical system OL3, image position correction (anti-vibration) when camera shake occurs is performed by moving, as an anti-vibration lens group Gvr, the cemented positive lens formed by cementing the positive lens L35 and the negative lens L36 in the third lens group G3, with a displacement component in the direction perpendicular to the optical axis.

Table 7 below shows values of specifications of the optical system OL3.

TABLE 7
Third example

| | | Intermediate | Telephoto |
|---|---|---|---|
| | Wide-angle | focal | end |
| [Overall specifications] | end state | length state | state |
| f = | 16.502~ | 34.999~ | 67.828 |
| FNO = | 3.500~ | 4.770~ | 5.773 |
| ω [°] = | 43.310~ | 21.951~ | 11.554 |
| Y = | 14.000~ | 14.750~ | 14.750 |
| TL (air-conversion length) = | 76.004~ | 89.037~ | 106.083 |
| BF (air-conversion length) = | 12.030~ | 12.029~ | 12.029 |

| [Lens data] | | | | |
|---|---|---|---|---|
| m | r | d | nd | νd |
| Object plane | ∞ | D0 | | |
| 1 | 48.0524 | 1.2000 | 1.75520 | 27.57 |
| 2 | 34.0110 | 4.8884 | 1.59349 | 67.00 |
| 3 | 509.4040 | D3 | | |
| 4* | 395.5500 | 0.8000 | 1.88300 | 40.66 |
| 5 | 11.8956 | 3.5251 | | |
| 6 | −209.9720 | 0.8000 | 1.88300 | 40.66 |
| 7 | 48.4656 | 0.1000 | | |
| 8 | 20.5862 | 3.3282 | 1.84666 | 23.80 |
| 9 | −43.5392 | 0.3247 | | |
| 10 | −30.1065 | 0.8000 | 1.88300 | 40.66 |
| 11 | 256.0370 | D11 | | |
| 12 | ∞ | 0.1000 | | Aperture stop S |
| 13 | 21.5223 | 1.9118 | 1.74397 | 44.85 |
| 14 | −74.8158 | 0.1000 | | |
| 15 | 12.9770 | 2.5268 | 1.51860 | 67.26 |
| 16 | −39.6511 | 0.8000 | 1.75019 | 33.24 |
| 17 | 35.0704 | 1.3912 | | |
| 18 | 11.7890 | 0.9978 | 1.75520 | 27.58 |
| 19 | 8.2456 | 1.6000 | | |
| 20 | 17.9605 | 3.1584 | 1.52394 | 66.78 |
| 21 | −11.7312 | 0.8002 | 1.72815 | 30.28 |
| 22 | −25.6067 | D22 | | |
| 23* | −88.9313 | 0.8000 | 1.64222 | 56.35 |
| 24 | 15.7846 | D24 | | |
| 25* | −38.0707 | 2.0920 | 1.53113 | 55.75 |
| 26* | −38.5185 | 1.5002 | | |
| 27 | 10425.2000 | 3.3408 | 1.73391 | 28.49 |
| 28 | −39.2547 | BF | | |
| Image plane | ∞ | | | |

| [Focal length of lens groups] | First | Focal |
|---|---|---|
| Lens group | surface | length |
| First lens group G1 | 1 | 101.016 |
| Second lens group G2 | 5 | −15.140 |
| Third lens group G3 | 13 | 14.800 |
| Fourth lens group G4 | 24 | −20.811 |
| Fifth lens group G5 | 26 | 52.040 |

In the optical system OL3, the fourth surface, the twenty-third surface, the twenty-fifth surface, and the twenty-sixth surface are formed in aspheric shapes. Table 8 below shows aspheric surface data, in other words, the values of the conic constant K and the aspheric surface constants A4 to A10 for the surface number m.

TABLE 8

| m | K | A4 | A6 | A8 | A10 |
|---|---|---|---|---|---|
| 4 | 1.0000 | 3.00000E−06 | 2.61478E−08 | −1.13102E−10 | 8.17656E−14 |
| 23 | 1.0000 | −9.70000E−05 | 4.54609E−07 | 1.98225E−08 | 0.00000E+00 |
| 25 | 1.0000 | 1.16155E−04 | 0.00000E+00 | 0.00000E+00 | 0.00000E+00 |
| 26 | 1.0000 | 8.90000E−05 | 2.17837E−08 | 2.94083E−10 | 0.00000E+00 |

In the optical system OL3, an on-axis air space D3 between the first lens group G1 and the second lens group G2, an on-axis air space D11 between the second lens group G2 and the aperture stop S, an on-axis air space D22 between the third lens group G3 and the fourth lens group G4, an on-axis air space D24 between the fourth lens group G4 and the fifth lens group G5, and the back focus BF change at zooming. Table 9 below shows variable spaces in the wide-angle end state, the intermediate focal length state, and the telephoto end state at focusing on an infinite distance object and at focusing on a close distance object.

TABLE 9
[Variable space data]

| | Focusing on infinite distance object | | | Focusing on close distance object | | |
|---|---|---|---|---|---|---|
| | Wide angle | Intermediate | Telephoto | Wide angle | Intermediate | Telephoto |
| f | 16.502 | 34.999 | 67.828 | — | — | — |
| β | — | — | — | 0.1169 | 0.1020 | 0.1224 |
| D0 | ∞ | ∞ | ∞ | 124.2630 | 311.2130 | 494.3130 |
| D3 | 1.4783 | 14.5148 | 31.4735 | 1.4783 | 14.5148 | 31.4735 |
| D11 | 18.6460 | 8.0611 | 1.4813 | 18.6460 | 8.0611 | 1.4813 |
| D22 | 1.4972 | 3.6764 | 7.2679 | 2.3120 | 4.6827 | 9.3820 |
| D24 | 5.4966 | 13.8975 | 16.8934 | 4.6770 | 12.8963 | 14.7768 |
| BF | 12.0303 | 12.0290 | 12.0290 | 12.0398 | 12.0316 | 12.0313 |

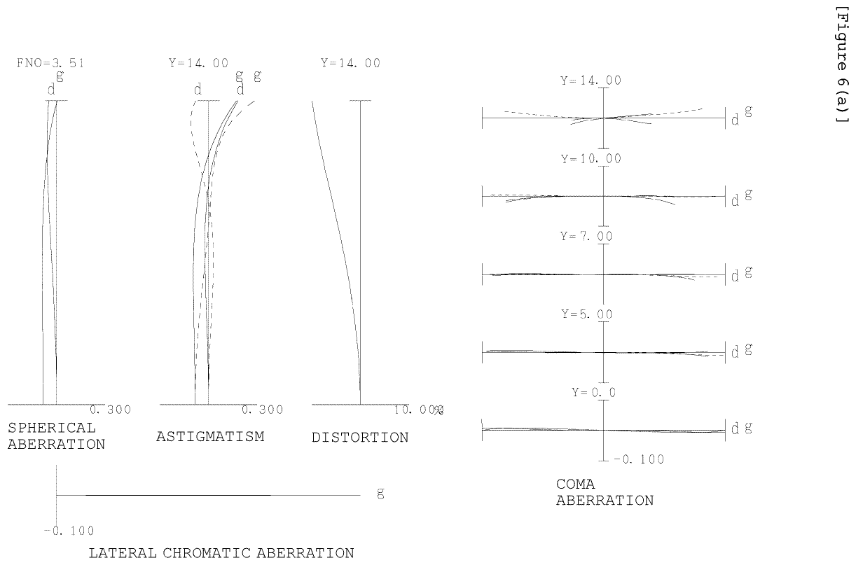

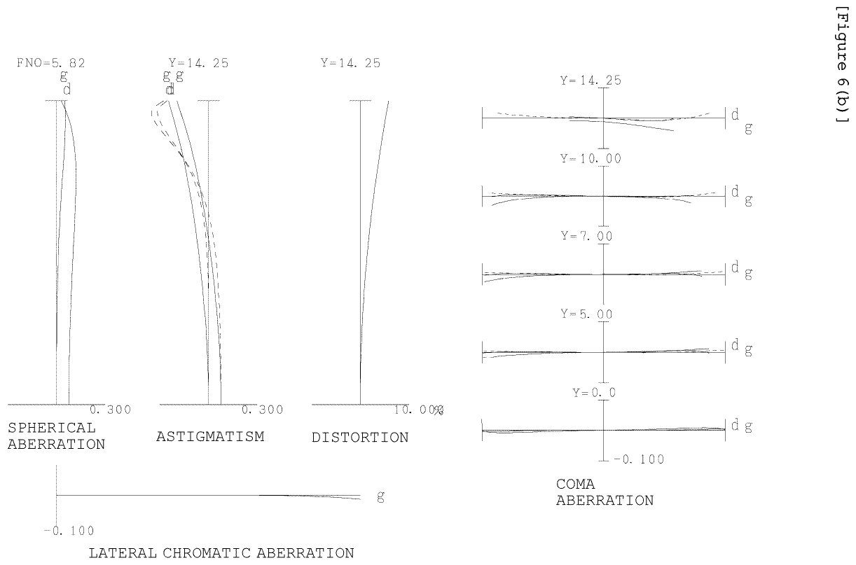

FIG. 6 shows a spherical aberration diagram, an astigmatism diagram, a distortion diagram, a lateral chromatic aberration diagram, and a coma aberration diagram of the optical system OL3 at focusing on an infinite distance object. Note that, in FIG. 6, (a) shows the wide-angle end state and (b) shows the telephoto end state. The aberration diagrams show that the optical system OL3 allows favorable correction of the variety of aberrations and has excellent imaging performance.

### Fourth Example

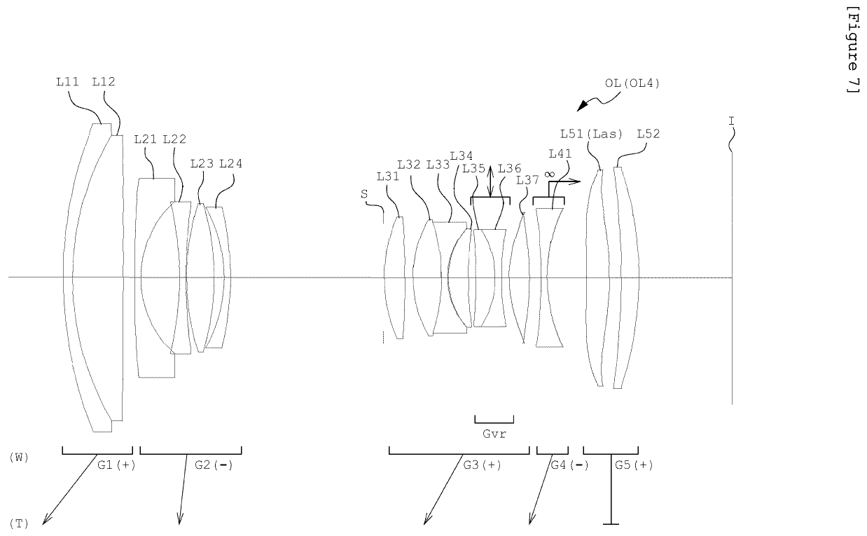

FIG. 7 is a diagram showing the configuration of the optical system OL4 according to a fourth example. The optical system OL4 includes, sequentially from the object side, a first lens group G1 having positive refractive power, a second lens group G2 having negative refractive power, a third lens group G3 having positive refractive power, a fourth lens group G4 having negative refractive power, and a fifth lens group G5 having positive refractive power.

The first lens group G1 is constituted by one lens component and includes a cemented positive lens formed by cementing a negative lens L11 in a meniscus shape having a convex surface facing the object side and a biconvex positive lens L12 sequentially from the object side. The second lens group G2 includes, sequentially from the object side, a negative lens L21 in a meniscus shape formed with an aspheric lens surface on the object side and having a convex surface facing the object side, a biconcave negative lens L22, a biconvex positive lens L23, and a negative lens L24 in a meniscus shape having a concave surface facing the object side. The third lens group G3 includes, sequentially from the object side, a biconvex positive lens L31, a cemented negative lens formed by cementing a biconvex positive lens L32 and a biconcave negative lens L33, a positive lens L34 in a meniscus shape having a convex surface facing the object side, a cemented negative lens formed by cementing a positive lens L35 in a meniscus shape having a concave surface facing the object side and a biconcave negative lens L36, and a biconvex positive lens L37 formed with an aspheric lens surface on the object side and an aspheric lens surface on the image plane side. The fourth lens group G4 includes a biconcave negative lens L41 formed with an aspheric lens surface on the image plane side. The fifth lens group G5 includes, sequentially from the object side, a positive lens L51 (specific aspheric lens Las) in a meniscus shape formed with an aspheric lens surface on the object side and an aspheric lens surface on the image plane side and having a concave surface facing the object side near the optical axis, and a positive lens L52 in a meniscus shape having a concave surface facing the object side.

In the optical system OL4, the space between adjacent lens groups changes at zooming from the wide-angle end state to the telephoto end state. Moreover, in the optical system OL4, at zooming from the wide-angle end state to the telephoto end state, the fifth lens group G5 is fixed relative to the image plane I, and the first lens group G1, the second lens group G2, the third lens group G3, and the fourth lens group G4 move to the object side along the optical axis.

In the optical system OL4, the fourth lens group G4 moves to the image plane side at focusing on from an infinite distance object to a close distance object.

In the optical system OL4, the aperture stop S is disposed between the second lens group G2 and the third lens group G3 (on the object side of the third lens group G3) and moves along the optical axis together with the third lens group G3 at zooming.

In the optical system OL4, image position correction (anti-vibration) when camera shake occurs is performed by moving, as an anti-vibration lens group Gvr, the cemented negative lens formed by cementing the positive lens L35 and the negative lens L36 in the third lens group G3, with a displacement component in the direction perpendicular to the optical axis.

Table 10 below shows values of specifications of the optical system OL4.

TABLE 10
Fourth example

| | | Intermediate | Telephoto |
|---|---|---|---|
| | Wide-angle | focal | end |
| [Overall specifications] | end state | length state | state |
| f = | 16.502~ | 34.997~ | 67.780 |
| FNO = | 2.890~ | 3.991~ | 4.932 |
| ω [°] = | 43.263~ | 22.003~ | 11.573 |
| Y = | 14.000~ | 14.750~ | 14.750 |
| TL(air-conversion length) = | 86.003~ | 98.293~ | 116.005 |
| BF(air-conversion length) = | 11.971~ | 11.959~ | 11.969 |

| [Lens data] | | | | |
|---|---|---|---|---|
| m | r | d | nd | νd |
| Object plane | ∞ | D0 | | |
| 1 | 52.5459 | 1.2000 | 1.75520 | 27.57 |
| 2 | 35.6184 | 6.5345 | 1.59349 | 67.00 |
| 3 | −2803.6700 | D3 | | |
| 4* | 235.7020 | 0.8000 | 1.81547 | 45.40 |
| 5 | 13.1175 | 4.9765 | | |
| 6 | −39.5909 | 0.8000 | 1.88300 | 40.66 |
| 7 | 65.3201 | 0.1000 | | |
| 8 | 30.9937 | 3.5582 | 1.84154 | 23.98 |
| 9 | −32.3449 | 1.2628 | | |
| 10 | −18.2775 | 0.8000 | 1.88300 | 40.66 |
| 11 | −37.9302 | D11 | | |
| 12 | ∞ | 0.1000 | | Aperture stop S |
| 13 | 19.5690 | 2.6532 | 1.77250 | 49.62 |
| 14 | −109.0440 | 1.0273 | | |
| 15 | 14.8211 | 3.6527 | 1.69058 | 49.81 |
| 16 | −24.1754 | 0.8000 | 1.81938 | 33.03 |
| 17 | 9.3673 | 0.1000 | | |
| 18 | 9.7506 | 2.5236 | 1.51591 | 67.50 |
| 19 | 40.4058 | 0.9900 | | |
| 20 | −80.7622 | 2.5081 | 1.84666 | 23.80 |
| 21 | −11.5697 | 0.8000 | 1.79430 | 30.21 |
| 22 | 34.0266 | 0.9762 | | |
| 23* | 15.1938 | 2.6235 | 1.48749 | 70.40 |
| 24* | −32.5525 | D24 | | |
| 25 | −61.0932 | 0.8000 | 1.62041 | 60.32 |
| 26* | 22.5651 | D26 | | |
| 27* | −168.7180 | 2.9621 | 1.53113 | 55.75 |
| 28* | −35.0432 | 1.4997 | | |
| 29 | −102.1540 | 2.2833 | 1.48749 | 70.40 |
| 30 | −44.3580 | BF | | |
| Image plane | ∞ | | | |

| [Focal length of lens groups] | First | Focal |
|---|---|---|
| Lens group | surface | length |
| First lens group G1 | 1 | 99.228 |
| Second lens group G2 | 5 | −14.815 |
| Third lens group G3 | 13 | 17.523 |
| Fourth lens group G4 | 26 | −26.464 |
| Fifth lens group G5 | 28 | 55.191 |

In the optical system OL4, the fourth surface, the twenty-third surface, the twenty-fourth surface, the twenty-sixth surface, the twenty-seventh surface, and the twenty-eighth surface are formed in aspheric shapes. Table 11 below shows aspheric surface data, in other words, the values of the conic constant K and the aspheric surface constants A4 to A10 for the surface number m.

TABLE 11

| m | K | A4 | A6 | A8 | A10 |
|---|---|---|---|---|---|
| 4 | 1.0000 | 9.00000E−06 | −1.79978E−08 | 1.10385E−11 | 3.07106E−13 |
| 23 | 1.0000 | −9.90000E−05 | −2.38813E−07 | 2.54537E−09 | 0.00000E+00 |
| 24 | 1.0000 | 5.60000E−05 | 0.00000E+00 | 0.00000E+00 | 0.00000E+00 |
| 26 | 1.0000 | 5.70000E−05 | −3.58096E−07 | 5.63082E−10 | 0.00000E+00 |
| 27 | 1.0000 | 5.70000E−05 | 0.00000E+00 | 0.00000E+00 | 0.00000E+00 |
| 28 | 1.0000 | 4.80000E−05 | 3.93298E−08 | −1.63554E−11 | 0.00000E+00 |

In the optical system OL4, an on-axis air space D3 between the first lens group G1 and the second lens group G2, an on-axis air space D11 between the second lens group G2 and the aperture stop S, an on-axis air space D24 between the third lens group G3 and the fourth lens group G4, an on-axis air space D26 between the fourth lens group G4 and the fifth lens group G5, and the back focus BF change at zooming. Table 12 below shows variable spaces in the wide-angle end state, the intermediate focal length state, and the telephoto end state at focusing on an infinite distance object and at focusing on a close distance object.

TABLE 12
[Variable space data]

| | Focusing on infinite distance object | | | Focusing on close distance object | | |
|---|---|---|---|---|---|---|
| | Wide angle | Intermediate | Telephoto | Wide angle | Intermediate | Telephoto |
| f | 16.502 | 34.997 | 67.780 | — | — | — |
| β | — | — | — | 0.1242 | 0.1046 | 0.1242 |
| D0 | ∞ | ∞ | ∞ | 113.9920 | 301.7060 | 483.9930 |
| D3 | 1.4728 | 12.9532 | 28.6920 | 1.4728 | 12.9532 | 28.6920 |
| D11 | 19.6693 | 8.2328 | 1.4897 | 19.6693 | 8.2328 | 1.4897 |
| D24 | 1.4956 | 5.1439 | 10.8180 | 2.5192 | 6.5475 | 13.8389 |
| D26 | 5.0342 | 13.6346 | 16.6689 | 4.0038 | 12.2305 | 13.6564 |
| BF | 11.9705 | 11.9592 | 11.9692 | 12.2973 | 12.1629 | 12.2525 |

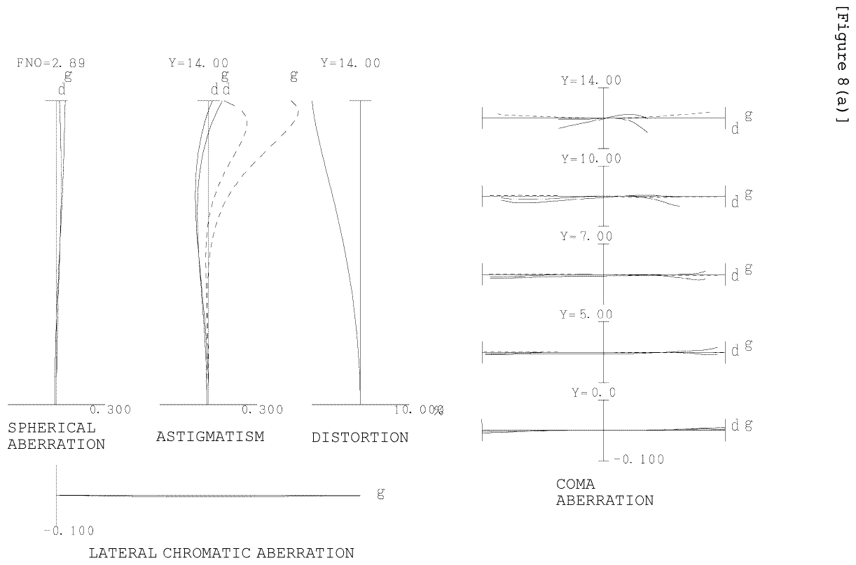

FIG. 8 shows a spherical aberration diagram, an astigmatism diagram, a distortion diagram, a lateral chromatic aberration diagram, and a coma aberration diagram of the optical system OL4 at focusing on an infinite distance object. Note that, in FIG. 8, (a) shows the wide-angle end state and (b) shows the telephoto end state. The aberration diagrams show that the optical system OL4 allows favorable correction of the variety of aberrations and has excellent imaging performance.

### [Conditional Expression Correspondence Value]

Table 13 below shows correspondence values of Conditional Expressions (1) to (15) in the first to fourth examples.

TABLE 13

(1) f1/f3
(2) TLw/fw
(3) (−f2)/f3
(4) f2/f4
(5) f1/(−f2)
(6) (−f2)/f5
(7) f3/f5
(8) f1/fw
(9) (D34t − D34w)/fw
(10) |f12w|/fw
(11) Bfw/fw
(12) |fvr|/f3
(13) (D23w/TLw) × (ft/fw)
(14) fw/|fg5as|
(15) ωw [°]

| | First | Second | Third | Fourth |
|---|---|---|---|---|
| | example | example | example | example |
| f12w | −19.647 | −18.775 | −19.270 | −19.120 |
| fvr | −32.835 | — | 25.403 | −33.749 |
| fg5as | 87.370 | 9561.272 | 9935.908 | 82.640 |
| (1) | 6.165 | 5.525 | 6.825 | 5.663 |
| (2) | 5.212 | 5.029 | 4.606 | 5.210 |
| (3) | 0.890 | 0.874 | 1.023 | 0.845 |
| (4) | 0.643 | 0.504 | 0.728 | 0.560 |
| (5) | 6.931 | 6.321 | 6.672 | 6.698 |
| (6) | 0.262 | 0.335 | 0.291 | 0.268 |
| (7) | 0.295 | 0.383 | 0.284 | 0.317 |
| (8) | 6.473 | 5.289 | 6.122 | 6.013 |
| (9) | 0.516 | 0.335 | 0.350 | 0.565 |
| (10) | 1.191 | 1.137 | 1.168 | 1.159 |
| (11) | 0.725 | 0.730 | 0.729 | 0.725 |
| (12) | 1.895 | — | 1.716 | 1.926 |
| (13) | 0.990 | 0.487 | 1.008 | 0.940 |
| (14) | 0.189 | 0.002 | 0.002 | 0.200 |
| (15) | 43.245 | 43.266 | 43.310 | 43.263 |

### REFERENCE SIGNS LIST

1 camera (optical apparatus)
OL (OL1 to OL4) optical system
G1 first lens group
G2 second lens group
G3 third lens group
G4 fourth lens group
G5 fifth lens group
Gvr anti-vibration group

1. An optical system comprising, sequentially from an object side:
a first lens group having positive refractive power, a second lens group having negative refractive power, a third lens group having positive refractive power, a fourth lens group having negative refractive power, and a fifth lens group, wherein
a space between adjacent lens groups changes at zooming,
the second lens group is fixed relative to an image plane at zooming, and
the optical system satisfies a condition expressed by an expression below,
$$4. < f 1 / f 3 < 10.$$
in the expression,
f1: focal length of the first lens group, and
f3: focal length of the third lens group.

2. An optical system comprising, sequentially from an object side, a first lens group having positive refractive power, a second lens group having negative refractive power, a third lens group having positive refractive power, a fourth lens group having negative refractive power, and a fifth lens group, wherein
a space between adjacent lens groups changes at zooming, and
the optical system satisfies a condition expressed by expressions below,
$$4. < f 1 / f 3 < 10.$$
$$4. < TLw / fw < 8.$$
in the expressions,
f1: focal length of the first lens group,
f3: focal length of the third lens group,
fw: overall focal length of the optical system in a wide-angle end state, and
TLw: optical total length of the optical system in the wide-angle end state.

3. The optical system according to claim 1, wherein the optical system satisfies a condition expressed by an expression below,
$$0. 500 < ( - f 2 ) / f 3 < 3.000$$
in the expression,
f2: focal length of the second lens group, and
f3: focal length of the third lens group.

4. The optical system according to claim 1, wherein the optical system satisfies a condition expressed by an expression below,
$$0.4 < f 2 / f 4 < 2.000$$
in the expression,
f2: focal length of the second lens group, and
f4: focal length of the fourth lens group.

5. The optical system according to claim 1, wherein the optical system satisfies a condition expressed by an expression below,
$$4. 000 < f 1 / ( - f 2 ) < 8.000$$
in the expression,
f1: focal length of the first lens group, and
f2: focal length of the second lens group.

6. The optical system according to claim 1, wherein the optical system satisfies a condition expressed by an expression below,
$$0.1 < ( - f 2 ) / f 5 < 0.8$$
in the expression,
f2: focal length of the second lens group, and
f5: focal length of the fifth lens group.

7. The optical system according to claim 1, wherein the optical system satisfies a condition expressed by an expression below,
$$0.1 < f 3 / f 5 < 0.48$$
in the expression,
f3: focal length of the third lens group, and
f5: focal length of the fifth lens group.

8. The optical system according to claim 1, wherein the optical system satisfies a condition expressed by an expression below,
$$4.000 < f 1 / fw < 8.$$
in the expression,
fw: overall focal length of the optical system in a wide-angle end state, and
f1: focal length of the first lens group.

9. The optical system according to claim 1, wherein the fourth lens group moves along an optical axis at focusing.

10. The optical system according to claim 1, wherein the optical system satisfies a condition expressed by an expression below,
$$0.1 < ( D 34 t - D 34 w ) / fw < 0.8$$
in the expression,
fw: overall focal length of the optical system in a wide-angle end state,
D34w: on-axis air space between the third lens group and the fourth lens group in the wide-angle end state, and
D34t: on-axis air space between the third lens group and the fourth lens group in a telephoto end state.

11. The optical system according to claim 1, wherein the optical system satisfies a condition expressed by an expression below,
$$0.8 < \vert f 12 w \vert / fw < 1.5$$
in the expression,
fw: overall focal length of the optical system in a wide-angle end state, and
f12w: combined focal length of the first lens group and the second lens group in the wide-angle end state.

12. The optical system according to claim 1, wherein the optical system satisfies a condition expressed by an expression below,
$$0.1 < Bfw / fw < 2.$$
in the expression,
fw: overall focal length of the optical system in a wide-angle end state, and
Bfw: back focus of the optical system in the wide-angle end state.

13. The optical system according to claim 1, wherein at least part of the third lens group is an anti-vibration group that moves with a component in a direction perpendicular to an optical axis.

14. The optical system according to claim 13, wherein the optical system satisfies a condition expressed by an expression below,
$$1. < \vert fvr \vert / f 3 < 6.$$
in the expression,
f3: focal length of the third lens group, and
fvr: focal length of the anti-vibration group.

15. The optical system according to claim 1, wherein the optical system satisfies a condition expressed by an expression below,
$$0.2 00 < ( D 23 w / TLw ) \times ( ft / fw ) < 1.5$$
in the expression,
fw: overall focal length of the optical system in a wide-angle end state,
ft: overall focal length of the optical system in a telephoto end state,
TLw: optical total length of the optical system in the wide-angle end state, and
D23w: on-axis air space between the second lens group and the third lens group in the wide-angle end state.

16. The optical system according to claim 1, wherein
the fifth lens group includes an aspheric lens having an inflection point, and
the optical system satisfies a condition expressed by an expression below,
$$0. < fw / \vert fg 5 as \vert < 0.5$$
in the expression,
fw: overall focal length of the optical system in a wide-angle end state, and
fg5as: focal length of the aspheric lens.

17. The optical system according to claim 1, wherein the optical system satisfies a condition expressed by an expression below,
$$30. ° < ω w < 60. °$$
in the expression,
ωw: half angle of view of the optical system in a wide-angle end state.

18. An optical apparatus comprising the optical system according to claim 1.

19. A method for manufacturing an optical system including, sequentially from an object side, a first lens group having positive refractive power, a second lens group having negative refractive power, a third lens group having positive refractive power, a fourth lens group having negative refractive power, and a fifth lens group, the method comprising:
disposing the lens groups so that a space between adjacent lens groups changes at zooming;
disposing the lens groups so that the second lens group is fixed relative to an image plane at zooming; and
disposing the lens groups so that a condition expressed by an expression below is satisfied,
$$4. < f1 / f 3 < 10.$$
in the expression,
f1: focal length of the first lens group, and
f3: focal length of the third lens group.

20. A method for manufacturing an optical system including, sequentially from an object side, a first lens group having positive refractive power, a second lens group having negative refractive power, a third lens group having positive refractive power, a fourth lens group having negative refractive power, and a fifth lens group, the method comprising:
disposing the lens groups so that a space between adjacent lens groups changes at zooming; and
disposing the lens groups so that a condition expressed by expressions below is satisfied,
$$4. < f 1 / f 3 < 10.$$
$$4. < TLw / fw < 8. 000$$
in the expressions,
f1: focal length of the first lens group,
f3: focal length of the third lens group,
fw: overall focal length of the optical system in a wide-angle end state, and
TLw: optical total length of the optical system in the wide-angle end state.
